(19) United States
(12) Patent Application Publication
(10) Pub. No.: US 2017/0233128 A1
(43) Pub. Date: Aug. 17, 2017

(54) METHOD AND DEVICE FOR THE APPLICATION OF SHRINK FILM SLEEVE

(71) Applicant: KRONES AG, Neutraubling (DE)

(72) Inventors: Florian LANG, Bad Abbach (DE); Stefan SCHERL, Bernhardswald (DE); Thomas EGGL, Obertraubling (DE); Bernd BRAATZ, Muenchenbernsdorf (DE); Robert KRIEGER, Straubing (DE)

(21) Appl. No.: 15/320,312

(22) PCT Filed: Jan. 12, 2015
(86) PCT No.: PCT/EP2015/050424

§ 371 Date: Dec. 20, 2016

(30) Foreign Application Priority Data
Aug. 14, 2014 (DE) 10 2014 216 191.6

(51) Int. Cl. B65C 3/06; B29C 65/00; B65C 9/18; B29C 65/66; B65C 9/02; B65C 9/42

(52) U.S. Cl. CPC B65C 3/065; B65C 9/02; B65C 9/42; B65C 9/18; B29C 65/66; B29C 66/7371; B29C 66/63; B29C 66/52271; B29L 2031/744

(57) ABSTRACT

A method and a device for applying a shrink film sleeve to a container is provided. The method includes perforating the shrink film sleeve at predefined intervals, expanding the perforated shrink film sleeve by means of an expansion device, such as an expansion mandrel, conveying the expanded shrink film sleeve along the expansion device by a conveyor roller pair, tearing off the shrink film sleeve at the perforation by means of a downstream dispensing roller pair whose conveying speed is at least temporarily higher than the conveying speed of the conveyor roller pair, and shooting the torn-off shrink film sleeve onto the container.

The present invention relates to a method and a device for applying a shrink film sleeve to a container.

For providing bottles, cans or the like with tubular films or label jackets, viz. the so-called sleeves, fitting machines, likes those described e.g. in WO 00/66437, are used, comprising a device for expanding a flat film tube and for cutting off films and label jackets with a desired length.

Utility Model DE 20104972 U1 already shows a device for expanding and cutting off a film tube. A device for expanding a film tube by means of an expansion mandrel is described, the film tube being here pulled over the expansion mandrel in an axial direction whereby it is expanded in a radial direction. The device comprises a cutting unit arranged in the lower end area of the expansion mandrel and used for circumferentially cutting through the expanded film tube from the radially outer side, the radially inner side of the film tube being supported by the expansion mandrel. The expansion mandrel has here spring-loaded support elements provided on the level of the cutting means and supporting the film tube on the inner surface thereof. A problem arising in the case of this prior art is that, due to the idle time occurring when the film tube is being cut off, high performances cannot be achieved.

Also the device described in WO 00/66437 comprises a dimensionally stable expansion mandrel and works satisfactorily as long as the diameter of the film tube to be processed does not exceed a specific, comparatively narrow tolerance range. If the film sleeves are of inferior quality, i.e. if their diameter varies within a wide tolerance field, problems may, however, arise when the film tube is being cut, since a dimensionally stable expansion mandrel normally has in its lower area, which is located close to the cutting plane, an outer diameter corresponding to the smallest possible inner diameter of the film tube, so as to avoid the tube from getting stuck on the expansion mandrel. However, if the film tube diameter varies within the largest possible tolerance range, the gap existing between the inner surface of the tube and the outer surface of the mandrel may become so large that the tube is not sufficiently supported on the inner side thereof while a film sleeve is being cut off. The result is an untidy cut line having a wavy or frayed cut edge. This problem arises especially in the case of shrink film sleeves which are comparatively rigid and which additionally tend to tear.

Starting from the above, it is the object of the present invention to apply shrink film sleeves to containers in a high-performance process and without using cutting blades.

According to the present invention, this object is achieved by the features of claims 1 and 10.

According to the present invention, the flat-folded shrink film sleeve is first perforated, the perforations being applied at predefined intervals corresponding to the height of the so-called sleeves or labels. The shrink film sleeve is provided as a flat-folded tube. Perforating is carried out transversely to the longitudinal direction of the shrink film sleeve, i.e. transversely to the conveying direction T. The shrink film sleeve is then conveyed along the expansion device by a conveyor roller pair, i.e. it is pulled over the expansion device in an axial direction. The shrink film sleeve is thus expanded in a radial direction. The conveyor roller pair abuts on the expansion device and is thus able to convey the shrink film sleeve positioned therebetween.

The shrink film sleeve is torn off at the perforation, such tearing being carried out with the aid of a dispensing roller pair, which is located downstream when seen in the conveying direction T and whose tear-off conveying speed V_{tear-off} is at least temporarily higher than the conveying speed V_{convey} of the conveyor roller pair. The term conveying speed stands for the speed with which the respective rollers move the shrink film sleeve in an axial direction, i.e. the rotary speed of the rollers.

Due to the different conveying speeds of the roller pairs arranged in succession in the conveying direction, a pulling force is applied to the perforation, so that the shrink film sleeve tears at the perforation and the tear-off edges are moved apart.

At least temporarily means here that, in toto, the rollers will rotate at a higher speed at least long enough for allowing the shrink film sleeve to be torn off at the perforation due to a pulling force. The speed need not even be constant. The dispensing rollers may also rotate at a higher speed only through part of a rotation, in particular if not the entire roller circumference of the transfer roller is required for unwinding and tearing off.

Subsequently, the torn-off shrink film sleeve is shot onto a container, e.g. a bottle, can etc. The shrink film sleeve can subsequently be thermally shrunk onto the container via a shrink unit.

Due to the fact that the shrink film sleeve is no longer cut, but tears at the perforation, diameter tolerances are no longer of importance. Hence, also rigid shrink film sleeves can be severed with neat edges. A continuous process is possible, and it is no longer necessary to stop the process for severing. Thus, up to 70,000 torn-off shrink film sleeves or sleeves or labels can be applied to containers per hour. Damage to the rigid and sensible shrink films can be prevented effectively.

It will be advantageous when the material used for the shrink film is a PET material or an OPS or also PVC, and when the thickness of the film lies in particular in a range of 10-100 μm, preferably 15-60 μm.

Advantageously, the perforated shrink film sleeve is supplied to a buffer, i.e. a loop buffer, prior to step b), i.e. prior to expansion. With the aid of the buffer, the length of the shrink film tube conveyed in the buffer can be varied.

Advantageously, shooting (launching) is effected by the dispensing roller pair. This is particularly advantageous, since the torn-off shrink film sleeve, which is rigid anyhow, need not be taken hold of again by a new, additional roller pair downstream of the dispensing roller pair. On the one hand, the shrink film sleeve will thus be dealt with carefully and, on the other hand, the control and the structural design of the device will be simplified substantially. For shooting the torn-off shrink film sleeve onto the container, the dispensing roller pair will then be accelerated to a conveying speed which is higher than the conveying speed V_{tear-off} used for tearing off. The dispensing roller pair may, for the purpose of shooting, also have a conveying speed Vₛₕₒₒₜ, which corresponds to the conveying speed V_{tear-off}.

It follows that the dispensing roller pair has, advantageously, two functions simultaneously, viz. the tear-off function as well as the shooting function. This makes the system particularly cost-efficient and simple. When the dispensing roller pair can be driven with a conveying speed V_{tear-off} as well as with a higher conveying speed Vₛₕₒₒₜ, the respective speeds can be adjusted precisely to the tear-off demands as well as to the shooting demands. This is more advantageous in comparison with only one increased speed for shooting and tearing off.

According to a preferred embodiment, the following phases are run through during steps c) to e), after the conveyor roller pair and the dispensing roller pair have previously been accelerated to a predetermined conveying speed during start of the system (phase 1).

The conveyor roller pair and the dispensing roller pair rotate at the same conveying speed in phase 2, the shrink film sleeve, which has not yet been torn off, being conveyed by the conveyor roller pair to the dispensing roller pair. In phase 3, the conveying speed of the dispensing roller pair is increased to a conveying speed V_{tear-off}, whereby the shrink film sleeve is torn off at the perforation and the tear-off edges are then pulled apart.

In phase 4, the dispensing roller pair is accelerated to a conveying speed Vₛₕₒₒₜ, which is preferably higher than the conveying speed for tearing off V_{tear-off}, whereby the torn-off shrink film sleeve is accelerated and shot.

In a fifth phase, the dispensing roller pair is decelerated to the conveying speed of the conveyor roller pair.

It is also possible that, between phases 3 and 4, the dispensing roller pair is first decelerated, in a phase 3a, to a conveying speed V_{convey} corresponding to the conveying speed of the conveyor roller pair, such that between phases 3 and 4 the torn-off label or the torn-off shrink film sleeve moves in synchronism with the shrink film sleeve, which is still present in one piece, i.e. in the form of a tube. In this case, the dispensing roller pair may also have a conveying speed Vₛₕₒₒₜ for shooting, which corresponds to the conveying speed V_{tear-off}.

Phases 2 to 5 may be continuously repeated in succession.

Advantageously, the conveying speed of the conveyor roller pair remains constant, especially during phases 2 to 5.

Advantageously, at least the dispensing roller pair is driven via a servo drive. This allows a precise adjustment of the various speeds, e.g. V_{tear-off}, Vₛₕₒₒₜ. It will be of advantage to drive also the conveyor roller pair by means of a servo drive.

According to a preferred embodiment, the container is conveyed below the expansion device by a conveyor in a conveying direction P, and the flat-folded shrink film sleeve is fed to the expansion device such that the flat side of the shrink film sleeve extends at an angle β of 0 to <90°, preferably 0°, relative to the conveying direction P. When the angle β=0°, this means that the flat side of the folded shrink film sleeve extends parallel to the conveying direction P, and will be applied in this direction to the expansion device and the container. This will be of advantage in particular when shrink film sleeves are applied to special-shaped bottles, especially bottles having an elongate or an oval cross-section. Such special-shaped bottles can be conveyed on the conveyor, i.e. on the conveyor belt by way of example, only when they are oriented in a longitudinal direction, since otherwise they tend to tilt. When the shrink film sleeve is rotated by 90° in the area of the expansion device, so that the fold of the folded shrink film sleeve will come to lie in the lateral area of the special-shaped bottle instead of on the front of the latter, this entails the drawback that the perforation may tear in an uncontrollable manner when a tear-off unit is used.

According to the present invention, the folded, perforated shrink film sleeve for special-shaped bottles is, however, fed such that its flat side no longer extends perpendicular to the conveying direction P, but preferably parallel to the conveying direction P. Therefore, undesirable wrinkles or welded seams in the front area of the respective special-shaped bottle can be prevented. Likewise, the angle β may, however, also lie within a range of 0 to <90°. This allows precise positioning of the edge on the circumference. It follows that, depending on the respective shape of the bottle, the shrink film sleeve can be fed to the expansion device at a suitable angle. The shrink film sleeve need not be turned in the area of the expansion device.

The formulation flat side of the folded film tube stands for the planar front or back.

The device according to the present invention comprises a control unit, which adequately controls the drives of the conveyor roller pair and of the dispensing roller pair for the purpose of tearing off, and in particular for shooting. The device may comprise a perforator, but the shrink film sleeves may also be perforated in advance in some other unit.

Preferably, the device comprises a buffer located downstream of the perforator.

According to a further embodiment, the conveyor roller pair and the dispensing roller pair may be driven continuously, each at a constant speed, the conveying speed of the dispensing roller pair being advantageously up to 10 times higher than the conveying speed of the conveyor roller pair.

The distance between the conveyor roller pair and the dispensing roller pair is advantageously adjustable via an adjustment unit.

The device comprises a conveyor, which is arranged below the expansion device and which conveys the container in a conveying direction P, and a feed unit, which is arranged such that the flat-folded shrink film sleeve is fed to the expansion device in such a way that the flat side of the shrink film sleeve extends at an angle of 0 to <90°, preferably 0°, relative to the conveying direction P. The feed unit may also be configured such that it is adjustable so that the angle β can be adjusted in a range of 0-90° and adapted to a specific bottle shape.

In the following, the present invention will be explained in more detail making reference to the following figures:

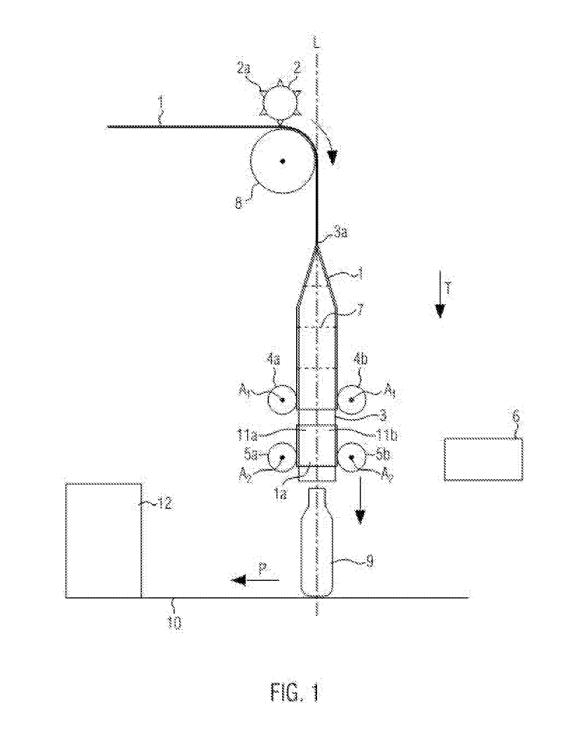

FIG. 1 shows schematically a side view of an embodiment according to the present invention.

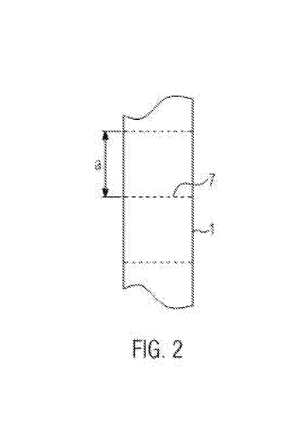

FIG. 2 shows, in a highly schematic representation, a portion of a tubular, flat-folded shrink film sleeve with perforations.

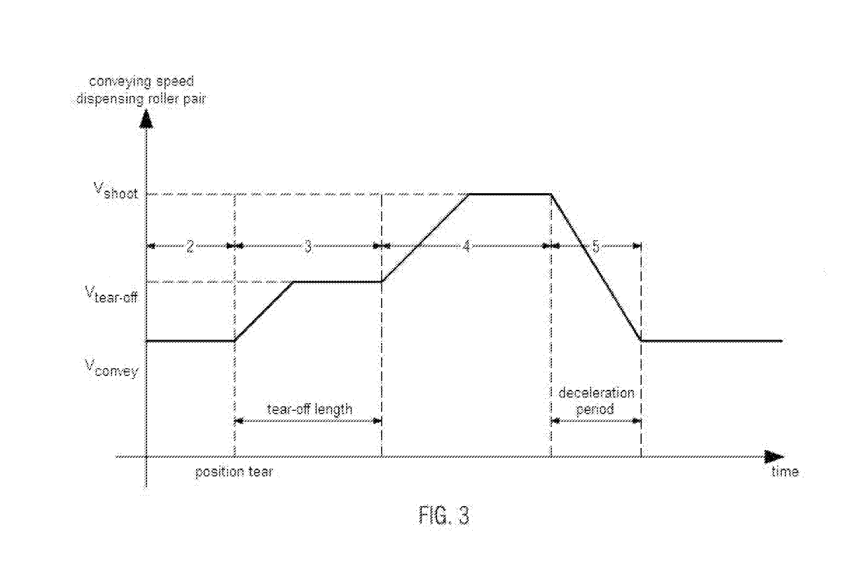

FIG. 3 shows a diagram in which the conveying speed of the dispensing roller pair is plotted against time.

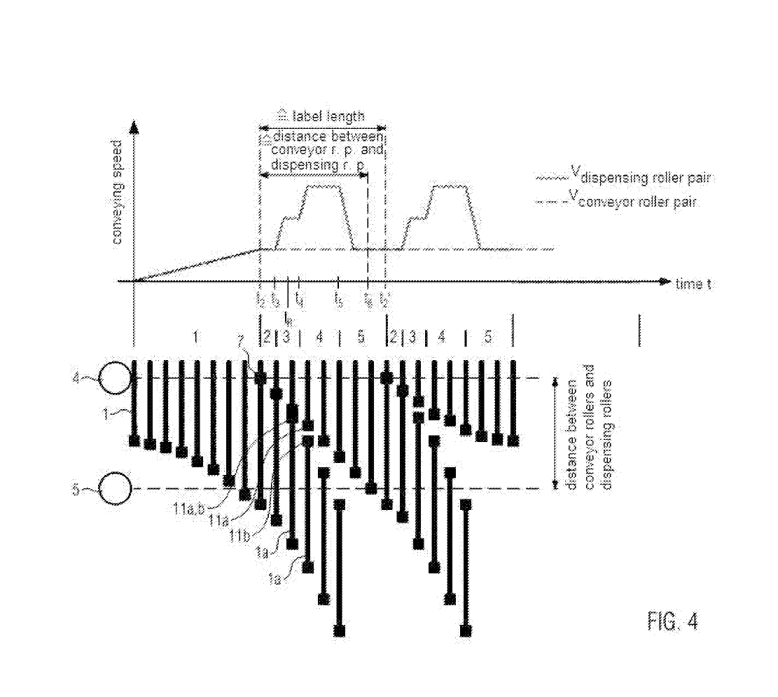

FIG. 4 shows a diagram in which the conveying speed of the conveyor roller pair and of the dispensing roller pair is plotted against time, as well as positions of the shrink film sleeve corresponding thereto.

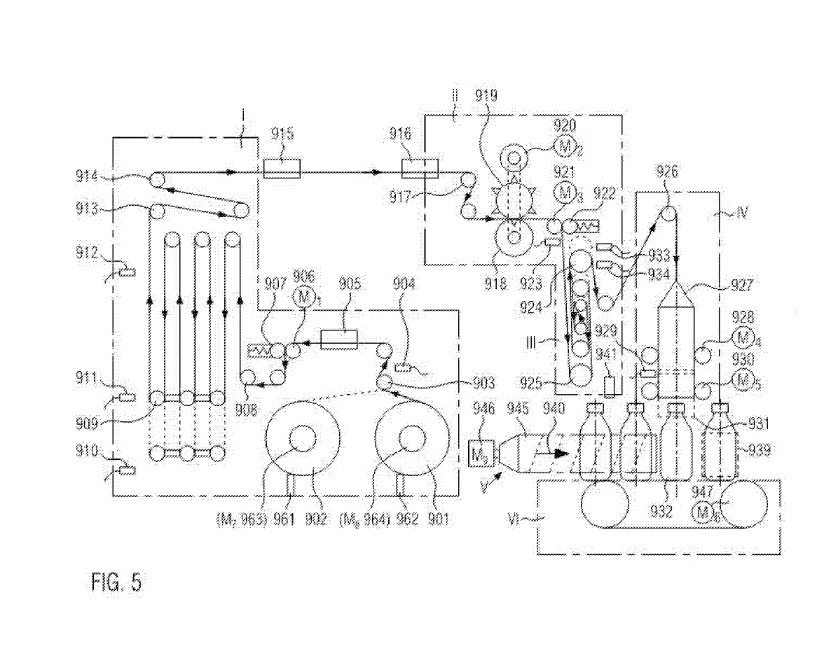

FIG. 5 shows schematically an overall view of a shrink film sleeve unit for use of the device according to the present invention.

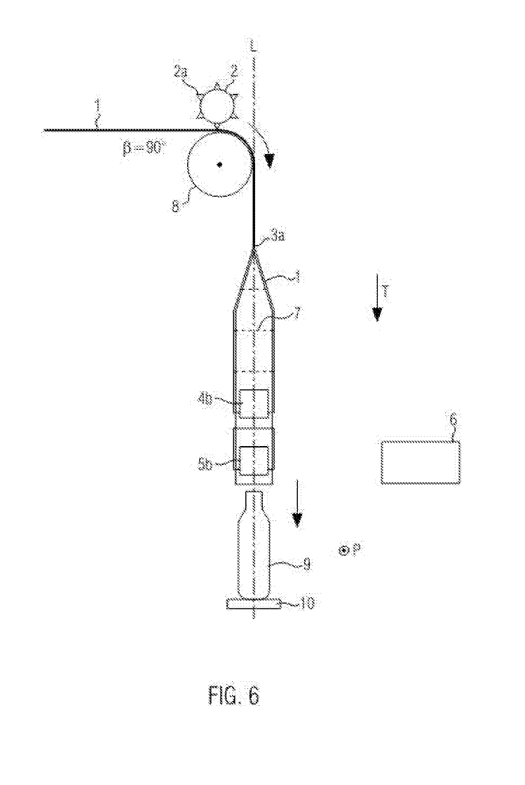

FIG. 6 shows a further embodiment of the present invention corresponding to the embodiment shown in FIG. 1, the shrink film sleeve being here fed with a displacement of 90°.

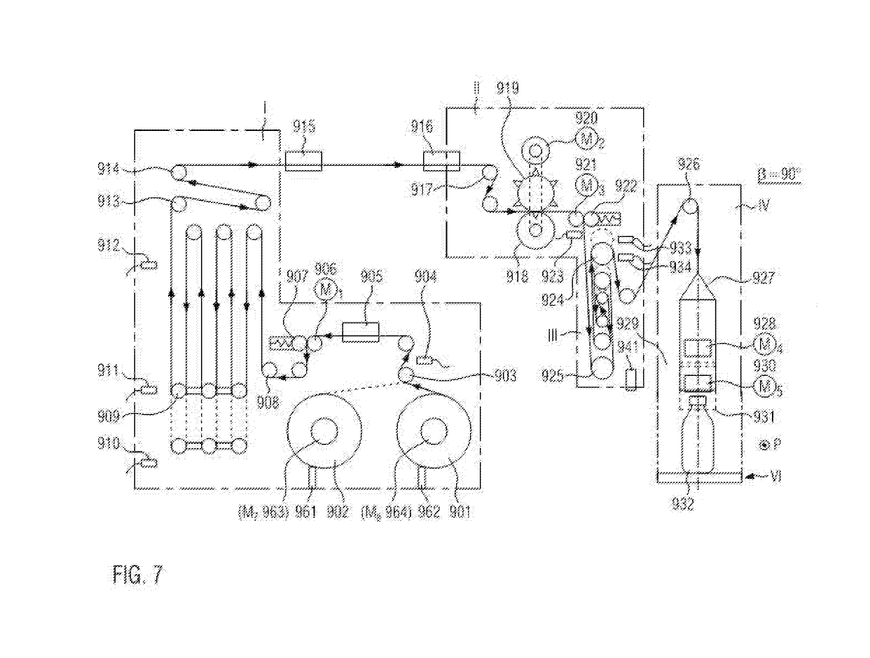

FIG. 7 shows the schematic overall view that it is shown in FIG. 5, with a 90° displacement of the angle β.

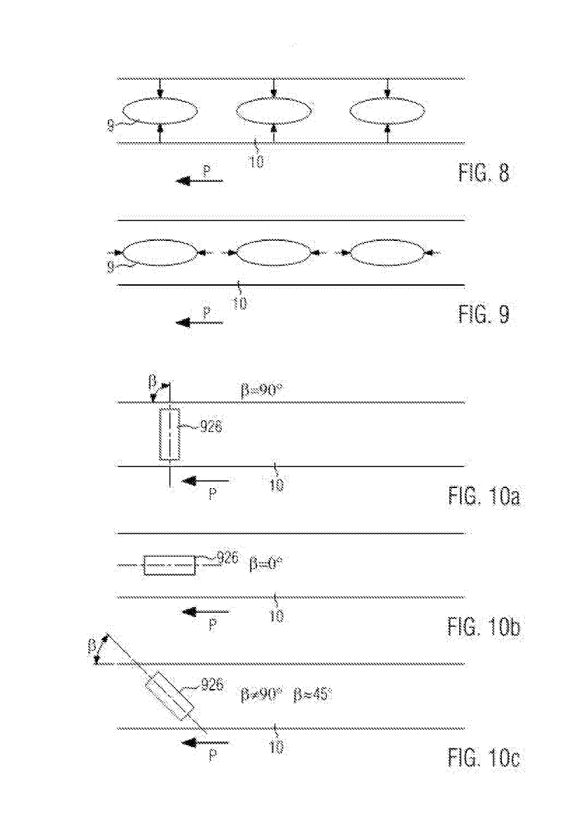

FIG. 8 shows schematically a section through special-shaped bottles, which are produced with an assembly of the type shown in FIGS. 1 and 5.

FIG. 9 corresponds to FIG. 8, the containers being here produced by means of the devices shown in FIGS. 6 and 7.

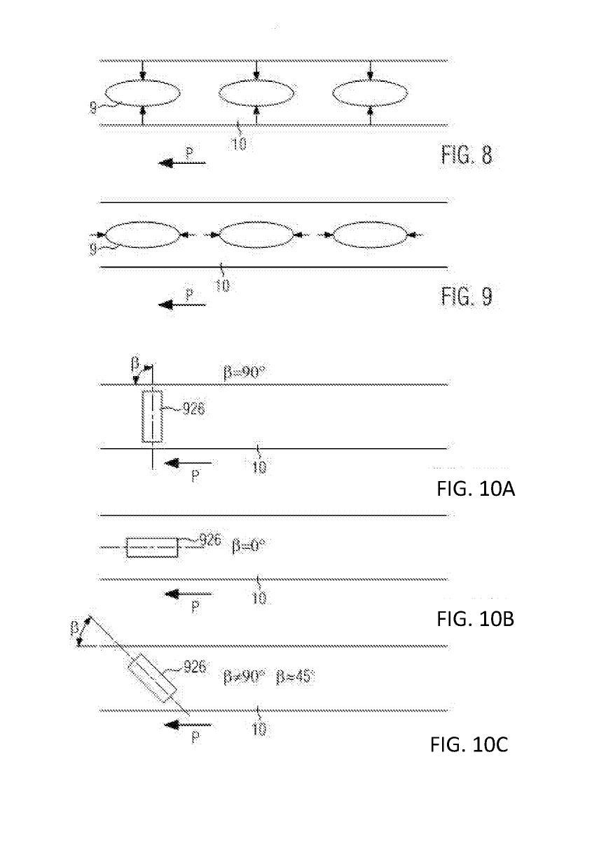

FIG. 10a shows, in a highly schematic representation, a top view of the conveyor belt with a supply roller arranged perpendicular to the conveying direction.

FIG. 10b corresponds to FIG. 10a, the supply roller being, however, oriented parallel to the conveying direction.

FIG. 10c corresponds to FIG. 10a and 10b with the supply roller being arranged at an oblique angle.

FIG. 5 shows, for better orientation, a detailed overall view of a shrink film sleeve unit for use of a device for applying shrink film sleeves according to the present invention. It goes without saying that the components shown in FIG. 5 may be replaced by alternative embodiments known in the prior art or may also be omitted as far as they are not essential to the above described further developments. The embodiment, which is exemplarily shown for the tear-off unit IV and which comprises a pair of conveyor rollers 928 and a pair of tear-off rollers 930, should, according to the present invention, be replaced by the further developments shown in FIG. 1. Hence, the components shown in FIG. 5 only serve to illustrate an assembly into which the above described further developments can be integrated.

FIG. 5 shows a shrink film sleeve unit composed of the assemblies I-VI. Assembly I stands for a label stocking unit comprising a loop buffer, assembly II for a perforating unit, assembly III for a loop buffer, assembly IV for a tear-off unit, assembly V for a bottle divider, and assembly VI for a conveyor.

In the label stocking unit I, a first supply roll 901 with a first shrink film tube and a second supply roll 902 with a second shrink film tube are exemplarily shown as stocking units. The first roll 901 can be driven via a first drive 964 by the motor M8, whereas the second roll 902 can be driven via a second drive 963 by the motor M7. Sensing elements 961 and 962 detect the amount of residual film that is present on the respective roll.

From the supply rolls one of the shrink film tubes is first guided via deflection rollers 903 past a sensor 904 and a gluing unit 905 to the loop buffer described hereinafter. When the shrink film tube supplied e.g. from supply roll 901 is used up, the end of the used-up shrink film tube can be glued by means of the glueing unit 905 onto the beginning of the next shrink film tube, i.e. the supply roll 902, so as to allow a continuous operation of the shrink film sleeve unit. For this purpose, the end of the used-up tube can be glued or spliced onto the beginning of the next tube manually or automatically. An example for automatic glueing is shown in EP 2062721 B1. The loop buffer described hereinafter allows the shrink film sleeve unit to be operated without interruption. The consequently endless shrink film tube is advanced via deflection rollers 908 to a first loop buffer.

Alternatively to the first drive 964 with motor M8 and the second drive 963 with motor M7, the supply of shrink film tubes may also be unwound by means of a drive roller 906 driven by a motor M1 and a spring-loaded counterroller 907, which are arranged downstream of the gluing unit 905.

The first loop buffer consists of a plurality of juxtaposed stationary and displaceable rollers, the plurality of displaceable rollers 909 being shown in FIG. 5 at the working position of the loop buffer. By moving the displaceable rollers 909 relative to the stationary rollers, a buffer function of the loop buffer can be realized. The loop buffer comprises here a sensor 910 for detecting an end position with maximum displacement of the displaceable rollers, a sensor 911 for detecting a working position and/or a sensor 912 for detecting a distance between the displaceable rollers and the stationary rollers, e.g. by means of a laser.

Subsequently, the shrink film tube is supplied via deflection rollers 913 and 914 and/or a guide tube 914, which includes air orifices for stabilizing the shrink film tube, to a manual or an automatic track control unit 915 for controlling the track of the film tube conveyed.

A guide element 916, configured e.g. as a stopper, guides the shrink film tube to the inlet of the perforating unit II. By means of deflection rollers 917, the not yet perforated shrink film tube is supplied to a perforator comprising a counterroll 918 and a perforating roll 919. The counterroll 918 may e.g. be configured such that it has a smooth surface or it may be configured as a corrugated roll. The perforating roll 919 may comprise a plurality of perforating blades, which are arranged along the longitudinal axis of the perforating roll and which each comprise a plurality of sharp teeth for perforating the shrink film tube, said teeth being adapted to be brought into engagement with the counterroll. To this end, the perforating blades are arranged at regular intervals along the circumference of the perforating roll 919. The perforating roll 919 and/or the counterroll 918 can be driven in a controlled manner, e.g. by means of a toothed belt and a drive 920 with a servo motor M2, so as to perforate the shrink film tube at regular, predefined intervals.

Via a deflector roll 921 driven by means of a motor M3 and a spring-loaded counterroll 922, the perforated shrink film tube is supplied, past a cutting mark sensor 923 for detecting a cutting mark provided on the shrink film tube, to a second loop buffer III. By means of the detected cutting mark, the upstream perforation unit is controlled via a control, which is not shown. The cutting mark sensor 923 may optionally also be located upstream of the perforator or of the perforation unit II.

Also the second loop buffer comprises a plurality of stationary rollers 925 and a plurality of movable rollers 924, by means of which the length of the shrink film tube conveyed in the loop buffer can be varied. In the embodiment shown here, the rollers are, however, arranged above one another. Also in this case, there may be a sensor 934 for the working position of the loop buffer and/or a distance sensor 933 for detecting the position of the movable rollers 924.

Via a further deflection roller 926, the perforated shrink film tube is finally supplied to the tear-off unit IV for tearing off and for shooting individual shrink film tubes. It should be emphasized once more that the exemplary embodiment shown here is to be replaced by the above described further developments according to the present invention, which are shown in the figures following hereinafter. The arrangement shown here only serves to illustrate the relative positioning of a tear-off unit in a shrink film sleeve unit.

In the non-representative embodiment shown here, the tear-off unit IV comprises an expansion mandrel 927 as an expansion device, the perforated shrink film tube being pulled over said expansion device. A conveyor roller pair 928, which is driven by a servo motor M4, conveys the shrink film tube, which has been pulled over the expansion mandrel 927, in the axial direction of the latter. At the lower end of the expansion mandrel, shrink film sleeves 931 are torn off the shrink film tube by means of tear-off and dispensing rollers 930, which are driven via a servo motor M5, and are shot onto the container 932 to be labelled, which is here shown as a bottle. A sensor 929 for detecting the tear-off edge of the shrink film sleeve to be torn off may be arranged between the conveyor rollers 928 and the tear-off rollers 930, so as to supply signals for controlling the drives M4 and M5.

The containers 932 are supplied to the labeling station in the area of the tear-off unit IV via a separating unit V and by means of the conveyor unit VI. To this end, a separating screw 945 is driven in a controllable manner by means of a drive 946 with a motor M9.

Simultaneously, the containers 932 are conveyed by a conveyor belt, which is driven by a drive 947 with a controllable motor M6, so that a conveying direction 940 for the containers 932, which are spaced apart in a desired manner, is obtained in the area of the labeling station. Subsequently, the conveyor belt can advance the containers provided with a shrink film sleeve 939 to a shrink unit, e.g. a shrink tunnel. A sensor 941 disposed upstream of the tear-off unit IV along the conveyor belt serves to discern the containers 932 so as to control and/or control in a closed-loop mode the motors M4, M5, M6 and M9 such that the torn-off shrink film sleeves can reliably be applied to the containers.

FIG. 1 shows in a simplified and highly schematic view, an embodiment of a device according to the present invention, which corresponds substantially to FIG. 4.

The device serves to apply a shrink film sleeve onto a container 9, the shrink film sleeve being first provided as a flat-folded tubular shrink film sleeve 1 and being delivered, via a conveyor which is not shown in detail, e.g. by means of rollers etc., from a label stocking unit comprising a buffer. The material of the shrink film sleeve is here e.g. PET, OPS or PVC and has a thickness of e.g. 10-100 μm, preferably 15-60 μm.

The device comprises a perforation unit 2, which, as indicated in FIG. 2, produces a perforation at regular intervals a, transversely to a conveying direction T and to the longitudinal direction of the endless tubular shrink film sleeve. In the present case, the perforation unit 2 is configured as a rotary perforator 2 comprising a plurality of juxtaposed (perpendicular to the image plane in FIG. 1) projections 2a which perforate the shrink film sleeve 1 (distance between the individual holes e.g. 0.5 or 0.75 mm). In the course of this process, the shrink film sleeve runs e.g. across the driven roller 8. FIG. 1 is a simplified sketch, the perforation unit may additionally be followed by a downstream buffer. In addition, the perforation unit may be configured such that a further perforation is formed as a tear-off aid.

The flat-folded shrink film sleeve is then conveyed in the direction of the expansion device 3, which is here the expansion mandrel 3. The expansion mandrel 3 has the tip 3a, over which the shrink film sleeve is pulled in the conveying direction T, i.e. in the axial direction of the expansion mandrel, whereby it is expanded in the radial direction. In the course of this process, the shrink film sleeve is conveyed by a conveyor roller pair 4a,b in the conveying direction. The conveyor roller pair is arranged on opposite sides of the expansion mandrel 3 such that the shrink film sleeve 1 is pressed against the expansion mandrel and can be conveyed in the conveying direction T through the rollers 4a,b. The rollers 4a,b rotate about respective axes A1, which extend here perpendicular to the longitudinal axis L of the expansion mandrel. The conveyor roller pair 4a,b is driven e.g. by a servo drive or servo motor at a specific conveying speed, in this case the rotational speed of the rollers. At a location downstream of the conveyor roller pair 4a,b, when seen in the conveying direction T, a dispensing roller pair 5a,b is arranged, which also rotates about respective axes A2 perpendicular to the longitudinal axis L of the expansion device 3 and which is driven by a respective servo drive or servo motor. A control unit 6 controls the conveying speeds of the conveyor roller pair 4a,b and of the dispensing roller pair 5a,b. The distance between the rollers depends on the respective case of use and on the respective label length and can be varied via a unit, which is not shown. In the case of a label having a length of 150 mm, the distance a is e.g. 160 mm (normally, the distance is equal to or slightly larger than the label length). In addition, the control unit 6 may also control the speeds of additional conveyor means, e.g. of the roller 8 and the perforator 2.

A conveyor 10 for containers 9, e.g. bottles, cans etc., is arranged below the above described assembly, the containers being conveyed on said conveyor in particular linearly, as indicated by the arrow P. The conveyor is followed by a unit 12 for thermally shrinking the torn-off shrink film sleeves 1a onto the container 9. This kind of unit is generally known and is therefore not described in more detail. In particular, a steam tunnel with 70-110° C. may be provided.

The diameter of the conveyor roller pair may correspond to the diameter of the dispensing roller pair. In the case of deviating diameters, the speed of the respective rollers will have to be adapted to the diameter in question so as to obtain a specific rotary speed and conveying speed. The diameters of the rollers 4a,b, 5a,b lie e.g. in a range between 25 and 75 mm.

The conveyor roller pair 4a,b serves to pull the shrink film sleeve 1 over the expansion mandrel 3 and to convey it in an axial direction as well as to support it for allowing the sleeve to be torn off. The dispensing roller pair 5a,b has the function of tearing off the shrink film sleeve at the perforation 7 and of shooting the torn-off shrink film sleeve onto the container 9.

In the following, the method according to the present invention will be explained in more detail making reference to FIGS. 1, 3 and 4.

To begin with, the tubular, still folded shrink film sleeve 1 is delivered via a conveyor system that is not shown. During this delivery, the conveyor roller pair 4a,b rotates at a predetermined conveying speed V_{convey} of e.g. 0.1 to 5 m/s. The speed can here be adapted to the length of the label. The folded shrink film sleeve is now perforated by means of the perforation unit 2, as shown in FIG. 2, such that successive perforations 7 are spaced apart at a distance a corresponding to the length a of a torn-off shrink film sleeve 1a, i.e. of a specific label etc. The perforation unit is controlled accordingly. There are e.g. two possibilities of controlling the perforator:

1. The perforating rotor 2 has provided thereon a servo motor. The latter accelerates the blade 2a to a speed that is synchronous with the conveying speed of the sleeve 2—after the cut it decelerates or accelerates and prepares the next blade 2a for the next cut. When the next cut is due, the servo motor returns to the synchronous speed and cuts, i.e. perforates.

2. The rotor 2 rotates at a medium speed, which is chosen such that, while a label is being conveyed by one label length through the perforator, the speed of the rotor 2 will be precisely such that the rotor will move from one blade 2 to the next. Although the rotor speed and the label speed are here not synchronous during the cut, this does not have any negative influence on the perforation. The utilized motor capacity of the servo is here much lower, since the motor need not be constantly controlled, so that, on the whole, a higher label conveying speed and consequently a higher throughput are realizable. The shrink film sleeve is here continuously advanced. It is also possible that perforation does not take place in the respective unit, but that the film was perforated in advance.

The shrink film sleeve is then expanded in a radial direction by means of the expansion mandrel 3, the conveyor roller pair 4a,b conveying the shrink film sleeve 1 at the predetermined conveying speed V_{convey}. The shrink film sleeve 1 is conveyed towards the dispensing roller pair 5a,b with the aid of the conveyor roller pair 4a,b, the conveying speed V_{convey} of the conveyor roller pair 4a,b corresponding here, in phase 2, to the conveying speed of the dispensing roller pair 5a,b, as can be seen from FIG. 3. After the shrink film sleeve has moved a few millimeters (e.g. 5-20 mm) into the dispensing roller pair 5a,b, and has been seized by the dispensing roller pair 5a,b, the conveying speed of the dispensing roller pair 5a,b is, as can especially be seen from FIG. 3, accelerated to a conveying speed V_{tear-off}, whereas the speed of the conveyor roller pair 4a,b remains constantly at V_{convey}. Due to the pulling forces acting on the perforation 7, the shrink film sleeve 1 tears at the perforation 7 in such a way that tear-off edges 11a,b, which can be seen from FIG. 1, are formed, said tear-off edges 11a,b being pulled apart (phase 3).

Phase 3 is followed by phase 4, in which the conveying speed of the dispensing roller pair 5a,b is further accelerated to a shooting speed Vₛₕₒₒₜ, whereby the torn-off shrink film sleeve 1a is accelerated to a shooting speed and shot onto the container 9.

In a phase 5, the dispensing roller pair is decelerated to the conveying speed V_{convey} of the conveyor roller pair 4a,b (phase 5), while the shrink film sleeve 1 is again being conveyed by the conveyor roller pair 4a,b to the dispensing roller pair 5a,b.

It is also possible to convey, between phases 3 and 4, the torn-off shrink film sleeve in synchronism with the subsequent shrink film sleeve in that, prior to being accelerated to the shooting speed Vₛₕₒₒₜ, the dispensing roller pair 5a,b is decelerated to the conveying speed of the conveyor roller pair 4a,b V_{convey}.

The speed V_{tear-off} is higher than the conveying speed V_{convey}. A comparatively small speed difference will already suffice, i.e. V_{tear-off} is e.g. at least 1.04 times as large as V_{convey}. The precise speed V_{tear-off} depends on the respective parameters, such as distance between the conveyor rollers and the dispensing rollers, length of the label, V_{convey} and material of the sleeve. For example, the speed V_{convey} of the conveyor rollers is 2.92 m/s, when the length of the torn-off film sleeve 1a or sleeve length is 150 mm and the distance between the conveyor roller and the dispensing roller is 160 mm (in the case of the above mentioned materials). The tear-off speed V_{tear-off} will then be e.g. 3.11 m/s. The speed Vₛₕₒₒₜmay be up to 10 times as high as V_{convey}.

Phases 2 to 5 are repeated continuously. According to the present embodiment, the speed of the conveyor roller pair 4a,b remains always constant.

FIG. 4 shows the method according to the present invention once more in detail. Just as in the case of FIG. 3, the conveying speed V is plotted against the time t. The broken line shows the speed of the conveyor roller pair 4a,b. The dotted line shows the speed of the dispensing roller pair 5a,b. Prior to phases 2 to 5, the rollers 5a,b, 4a,b are first accelerated to a predetermined conveying speed V_{convey}. At the moment in time t2, phase 2 starts, in which the conveyor roller pair 4a,b and the dispensing roller pair 5a,b are operated at the same conveying speed, as described above. Below the diagram, the transport of the shrink film sleeve 1 between rollers 4 and 5 is shown schematically. At the moment in time t2, e.g. a perforation 7 enters here the area of the conveyor roller pair 4a,b and is conveyed towards the dispensing roller pair 5a,b. The conveyor roller pair 4a,b always rotates at the same speed during phases 2 to 5. As described above, the dispensing roller pair 5a,b is accelerated to the speed V_{tear-off} at a moment in time t3 in phase 3, the pulling force, which acts on the perforation 7, being at a moment in time tr so strong that the shrink film sleeve is torn apart, whereby the tear-off edges 11a,b are formed, which are then pulled apart still further. At the moment in time t4, the speed of the dispensing roller pair 5a,b is accelerated still further up to a shooting speed Vₛₕₒₒₜ, whereby the torn-off label 1a is shot. As described above, the dispensing roller pair 5a,b is then decelerated such that it returns to the conveying speed V_{convey}. At the moment in time t2′, a new cycle begins, the plant being controlled such that, at said moment in time t2′, a perforation 7 will again be present in an area between the rollers 4a,b. The period between t2 and t2′ (i.e. phases 2 to 5) corresponds to the period required for conveying the shrink film sleeve by one “label length” (i.e. the length of a torn-off shrink film sleeve 1a) at the conveying speed V_{convey}. The period between the moments in time t2 and t6 corresponds to the period required for conveying the shrink film sleeve from roller pair 4a,b to roller pair 5a,b, in the present case the perforation 7 from roller 4 to roller 5. In phase 5, the conveyor roller pair and the dispensing roller pair can be maintained at the conveying speed V_{convey} until a new shrink film sleeve portion or label to be torn off arrives, here with the perforation 7. Subsequently, phase 2 begins once more.

FIG. 4 only shows an example for a control of the roller pairs. The only essential aspect is that the dispensing roller pair 5a,b can be accelerated to respective speeds V_{tear-off}, Vₛₕₒₒₜ for the purpose of tearing and shooting, whereas the conveyor roller pair 4a,b can be maintained at the conveying speed V_{convey}.

According to the above embodiments, the speed of the dispensing roller pair 5a,b was varied.

The conveyor roller pair 4a,b and the dispensing roller pair 5a,b may, however, also be driven continuously at respective constant speeds, which, however, differ from one another. The conveying speed of the dispensing roller pair will then be approximately 2-10 times higher than the conveying speed of the conveyor roller pair. No stop is required. The utilized motor capacity can thus be reduced substantially (e.g. from 125% to 30%). Also in this case, the dispensing rollers have a tear-off function as well as a shooting function. The distance between the conveyor roller pair 4a,b and the dispensing roller pair 5a,b must here be chosen such that it is larger than the distance a between two perforations 7.

The embodiment shown in FIG. 6 corresponds to the embodiment shown in FIG. 1, the angle 0 at which the flat-folded shrink film sleeve 1 is supplied to the expansion device 3, in this case the expansion mandrel, being displaced by 90°. As can be seen from FIG. 6a, the conveying direction P is here directed into the image plane. Hence, the flat side of the supplied shrink film sleeve extends, as can be seen from FIG. 6, parallel to the conveying direction P, i.e. the angle β, at which the flat side of the shrink film sleeve is oriented relative to conveying direction P, is here 0. The above applies in a corresponding manner to FIG. 7. FIG. 7 corresponds to FIG. 5, the angle β being, however, also in this case 0, as explained above.

As can be seen from FIG. 8, the mode of feeding the folded shrink film sleeves shown in FIGS. 1 and 5 is not suitable for use with special-shaped bottles, e.g. bottles having an elongate cross-section. If the shrink film sleeves were fed such that β=90°, the folded edges of the shrink film sleeve would, as can be seen from the arrows in FIG. 8, be located at the front of a bottle, and this would be disturbing to the eye. If, however, the shrink film sleeve were fed via a respective feed unit 8, 926 such that the flat side extends in the conveying direction P, i.e. in the direction of the linear conveyor, the folded edges can be arranged in the lateral areas, where they will disturb less.

FIG. 10a shows e.g. the orientation of a feed unit relative to the conveyor 10. The feed unit may e.g. be a conveyor roller or a deflection roller, e.g. the roller 8 in FIG. 1 or the roller 926 in FIG. 5. The roller is arranged above the expansion device such that the film tube can be fed directly to the tip 3a of the expansion device. In FIG. 10a, the feed unit 926, 8 extends perpendicular to the conveyor 10 and the conveying direction P. This kind of orientation corresponds to FIGS. 1 and 5. The angle β is here 90°. The angle β may, however, be varied. FIG. 10b shows an arrangement in which the feed unit extends parallel to the conveyor 10 in accordance with FIG. 6 and FIG. 7.

A different angle β may, however, be chosen as well, e.g. an angle in a range of from 0 to 90°, i.e. the feed unit is arranged at an oblique angle relative to the conveyor. Depending on the shape of the container or of the bottle, the shrink film sleeve can here be supplied to the expansion device at a specific angle β. The shrink film sleeve need not be turned in the area of the expansion device. Hence, the perforated labels can tear off in a controlled manner.

Advantageously, the orientation of the feed unit can be adjusted so as to adjust the angle β. Thus, containers of different shapes can be provided with labels in one and the same plant. For readjusting the feed unit, the feed unit may be arranged such that it is adjustable independently of the expansion device. This means that e.g. a respective feed module can be pivoted or mechanically readjusted relative to the expansion device. The module may e.g. also comprise the units I to III as well as the roller above the expansion device. Thus, the folded film tube may already be fed at a suitable angle via a supply unit to the device in its entirety.

1. A method for applying a shrink film sleeve to a container, comprising the following steps:
a) perforating the shrink film sleeve at predefined intervals,
b) expanding the perforated shrink film sleeve by means of an expansion device,
c) conveying the expanded shrink film sleeve along the expansion device by a conveyor roller pair,
d) tearing off the shrink film sleeve at the perforation by means of a downstream dispensing roller pair, wherein a conveying speed of the dispensing roller pair used for tearing off is at least temporarily higher than a conveying speed of the conveyor roller pair, and
e) shooting the torn-off shrink film sleeve onto the container.

2. The method according to claim 1, wherein prior to step b), the perforated shrink film sleeve is supplied to a buffer.

3. The method according to claim 1, wherein PET, OPS or PVC is used as a material for the shrink film, and wherein a thickness of the shrink film lies in a range of 10-100 μm.

4. The method according to claim 1, wherein the shooting is effected by means of the dispensing roller pair.

5. The method according to claim 1 wherein for shooting the torn-off shrink film sleeve onto the container, the dispensing roller pair is accelerated to a conveying speed used for shooting which is higher than the conveying speed of the dispensing roller pair used for tearing off,
or
wherein the conveying speed of the dispensing roller pair used for shooting corresponds to the conveying speed of the dispensing roller pair used for tearing off.

6. The method according to claim 1, wherein during steps c) to e), the following phases are run through, after the conveyor roller pair and the dispensing roller pair have previously been accelerated to a predetermined conveying speed in a phase 1:
the conveyor roller pair and the dispensing roller pair both rotate at the conveying speed of the conveyer roller pair, the shrink film sleeve being conveyed by the conveyor roller pair to the dispensing roller pair in a phase 2,
the conveying speed of the dispensing roller pair is increased to the conveying speed used for tearing off, whereby the shrink film sleeve is torn off at the perforation and the tear-off edges are pulled apart in a phase 3,
the dispensing roller pair is accelerated to a conveying speed used for shooting, which is higher than the conveying speed used for tearing off, whereby the torn-off shrink film sleeve is accelerated and shot in a phase 4, and
the dispensing roller pair is decelerated to the conveying speed of the conveyor roller pair in a phase 5.

7. The method according to claim 6, wherein between the phases 3 and 4, the dispensing roller pair is decelerated to the conveying speed of the conveyor roller pair in a phase 3a, so that the torn-off shrink film sleeve is conveyed in synchronism with the subsequent shrink film sleeve, and is only subsequently accelerated to the conveying speed used for shooting.

8. The method according to claim 6, wherein the phases 2 to 5 are continuously repeated.

9. The method according to claim 6, wherein the conveying speed of the conveyor roller pair is constant, during the phases 2 to 5.

10. The method according to claim 1, wherein at least the dispensing roller pair is driven via a servo drive.

11. The method according to claim 1, wherein the container is conveyed below the expansion device by a conveyor in a conveying direction, and wherein a flat-folded shrink film sleeve is fed to the expansion device such that a flat side of the shrink film sleeve extends at an angle β of 0 to <90°, relative to the conveying direction.

12. A device for carrying out the method according to claim 1, comprising:
an expansion device, wherein the expansion device is an expansion mandrel, for expanding a perforated shrink film sleeve,
a first conveyor roller pair for conveying the expanded shrink film sleeve along the expansion device,
a downstream dispensing roller pair for tearing off the shrink film sleeve at the perforation,
a control unit, which, for tearing off the shrink film sleeve, controls a drive of the dispensing roller pair such that the conveying speed of the dispensing roller pair used for tearing off is, at least temporarily, higher than a conveying speed of the conveyor roller pair.

13. The device according to claim 12, which additionally comprises a perforator for perforating the shrink film sleeve at predefined intervals, a downstream buffer being provided.

14. The device according to claim 12, wherein for shooting the torn-off shrink film sleeve, the control unit controls the drive of the dispensing roller pair such that a conveying speed of the dispensing roller pair used for shooting is higher than the conveying speed of the dispensing roller pair used for tearing off the shrink film sleeve
or
wherein the conveying speed of the dispensing roller pair used for shooting corresponds to the conveying speed of the dispensing roller pair used for tearing off the shrink film sleeve.

15. The device according to claim 12, wherein at least the dispensing roller pair is driven by means of a servo drive.

16. The method according to claim 1, wherein the conveyor roller pair and the dispensing roller pair are driven continuously, each at a constant speed, the conveying speed of the dispensing roller pair being up to 10 times higher than the conveying speed of the conveyor roller pair.

17. The device according to claim 12, wherein a distance between the conveyor roller pair and the dispensing roller pair is adjustable via an adjustment unit.

18. The device according to claim 12, wherein the device comprises a conveyor, which is arranged below the expansion device and which conveys a container in a conveying direction, and a feed unit, which is arranged such that a flat-folded shrink film sleeve is fed to the expansion device in such a way that a flat side of the shrink film sleeve extends at an angle of 0 to <90° relative to the conveying direction.

19. The device according to claim 12, wherein a feed unit is configured such that it is adjustable so as to adjust an angle between a flat side of the shrink film sleeve and a conveying direction of a conveyor in a range of 0-90°.

20. The method of claim 1, wherein the expansion device is an expansion mandrel.
